(19) United States
(12) Patent Application Publication
(10) Pub. No.: US 2006/0237921 A1
(43) Pub. Date: Oct. 26, 2006

(54) Enclosed and semi-enclosed orifice on a snowboard for expelling snow or other medium in an arced stream

(76) Inventor: Paul Michael Shaheen, Hermosa Beach, CA (US)

Correspondence Address: Michael McEntee;Suite 100, 15802 Chemical Lane, Huntington Beach, CA, 92649, US

(21) Appl. No.: 11/409,577

(22) Filed: Apr. 24, 2006

Related U.S. Application Data
(60) Provisional application No. 60/674,417, filed on Apr. 26, 2005.

(51) Int. Cl. B62B 13/00

(52) U.S. Cl. 280/14.21

(57) ABSTRACT

A snowboard having a means to scoop snow and direct it into an arc.

### CROSS-REFERENCE TO RELATED APPLICATIONS

Applicant claims the benefit of a Provisional Patent Application 60/674,417, filed Apr. 26, 2005.

### FEDERALLY SPONSORED RESEARCH

Not applicable

### SEQUENCE LISTING OR PROGRAM

Not applicable

### BACKGROUND OF THE INVENTION

The present invention regards an enclosed or semi-enclosed orifice on a snowboard designed with a removable attachment, hard-mounted attachment, or embedded system incorporated during manufacturing for the purpose of expelling snow, ice, and other relevant riding medium in an arced and continuous or intermittent stream during transport. The term snowboard is being defined in the present invention as a board used to transport, person or other, across snow, ice, and other relevant medium via sliding on a reduced friction surface. The term controller is being defined as the person or other dictating the orientation, speed, and other of the snowboard.

So far, no patents have been found that refer to the topic, function, or intention of the present invention. Prior art includes a snowboard with a V-shaped cutout in the tail which creates the arced stream during specific snow conditions. The prior art is only effective during a snow condition referred to as “deep powder”, where the medium of transport is characterized by deep, fluffy snow. Also, during the deep powder snow condition, the arced stream is always present during transport providing little to no control to the controller on the height, duration, and timing of the arced stream. In the present invention, the arced stream can be created during most or all snow conditions. Also, the parameters of the effect can be adjusted by the controller, including height, duration, and timing of the arced stream by mechanical or other means.

### SUMMARY OF THE INVENTION

The present invention creates an arced stream of the snow or other relevant medium. The orifice design allows that the arced stream effect is activated during transport conditions such that the snowboard is laying flat to the medium. During transport conditions such that the snowboard is sliding on either edge, the effect is reduced or eliminated. The benefit of the orifice design over prior art allows the controller to increase or decrease the effect of the arced stream depending on the state of transport, either flat to the medium or on either edge. The orifice design also can be effective during most or all snow conditions, unlike the prior art which is only effective during the deep powder snow conditions described previously. The present invention is defined as an enclosed or semi-enclosed orifice on the snowboard for the purpose of expelling snow or other relevant medium in an arced stream during transport. A scoop made out of metal, composite, or other material is incorporated to the orifice by removable or irremovable means. The scoop collects the snow or relevant medium during transport. The scoop is either fixed during manufacturing or adjustable by the controller by mechanical means. Since the scoop is located on the flat surface of the snowboard, it is in contact with the medium during all snow conditions. While the snowboard is transporting on either edge, the scoop is less to not effective in collecting snow. The scoop may be designed to not collect snow or other medium via rotation so as not to face direction of travel, or via removal and replacement with a part that is incapable of collecting snow, or via the addition of a plug that renders the scoop incapable of collecting snow. The orifice design on the snowboard surface opposite the medium, the top of the snowboards, shall be designed control and direct the arced streams. Control parameters of the arced stream include but are not limited to the following: continuity of the stream—continuous versus intermittent, quantity of streams—single versus multiple, state of the stream—on versus off, height, direction, shape, and diameter of the stream(s). The expulsion mechanism shall include motorized or non-motorized pump, fan, motor, or chute. The control mechanism shall be constructed from metal, composite, or other material.

### BRIEF DESCRIPTION OF THE DRAWINGS

FIG. 1 is a plan view of the prior art showing the V-shaped cutout.

FIG. 2 is a plan view of the present invention showing the orifice enclosed in the snowboard.

FIG. 3 is a cross-sectioned side view of the current invention showing the scoop and chute used for snow collection and expulsion.

FIG. 4 is an isometric view of the present invention scooping and expelling the medium.

### DESCRIPTION OF THE SPECIFIC EMBODIMENTS

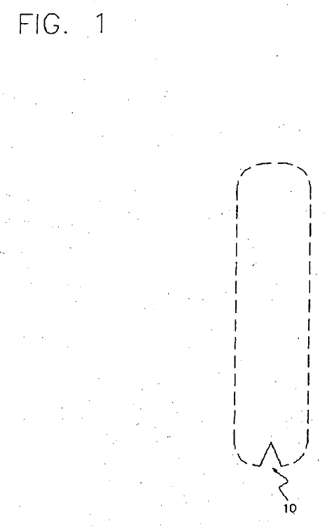

FIG. 1 shows the prior art which entails the V-shaped feature, 10, for expelling snow in an arced stream during deep powder snow conditions.

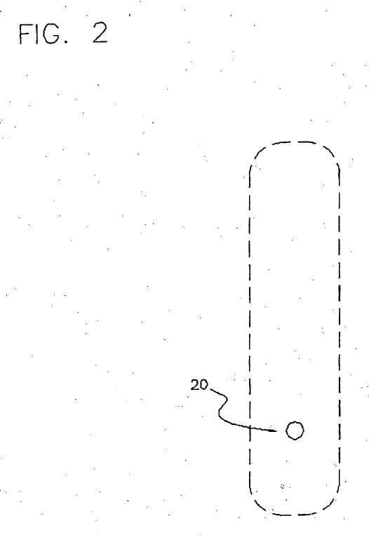

The plan view of the present invention 20 is shown in FIG. 2 where the enclosed or semi-enclosed orifice is located on the flat surface of the snowboard opposed to the flared ends enabling the snow or other medium to be expelled during all snow conditions.

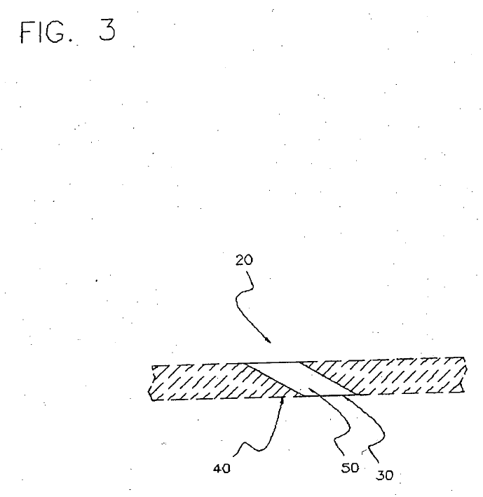

A cross-sectional side view of the present invention 20 in FIG. 3 shows the enclosed or semi-enclosed orifice 30 along with the scoop 40 for gathering the snow or other medium, and the chute 50 which aids in the expulsion of the medium.

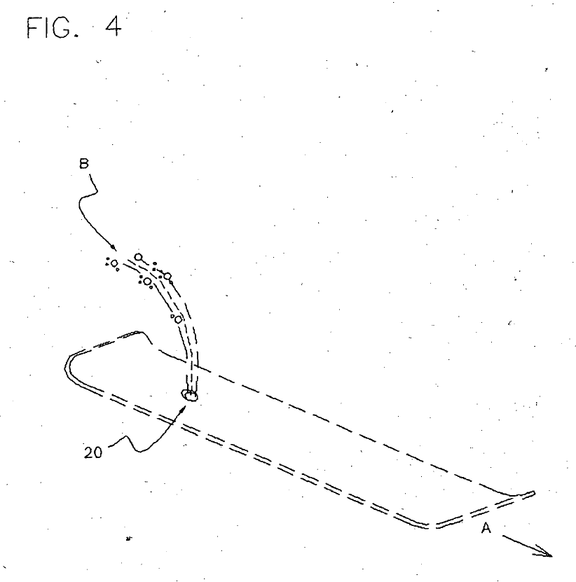

FIG. 4 shows the present invention 20 in action where the movement of the snowboard, A, creates B, the arced stream.

The snowboard shown typically has a laminated structure.

I claim:

1. A snow board adapted to slide on snow comprising, in combination,
a planar composite structure having a top side and a bottom side, and a means for scooping snow from part of the bottom side of the planar composite surface and passing that snow through at least one orifice in the planar surface, whereby the snow is ejected at substantially an acute angle above the top side of the planar surface.

2. The means of scooping snow described in claim 1 further comprising a duct having a first end and a second end, one part of said first end protrudes at a pre-selected distance below the bottom side of the planar composite surface to form a cutting edge.

3. The means of scooping snow described in claim 2 further comprising means to adjust the position of the duct to compensate for wear and tear of the part of the duct which protrudes at a pre-selected distance below the bottom surface of the planar composite surface.

4. The means of scooping snow of claim 1 further comprising aligning the long axis of the duct to form an acute angle with the bottom surface of the planar composite surface.

5. In claim 2, the duct means of scooping snow further comprising a removable cutting edge whereby wear and tear done by the snow and debris encountered in use while snow boarding can be easily repaired by removing part or all of the duct.

6. The removable duct in claim 5 further adapted to be placed in inverted position, thus achieving double use of the same part.

7. The removable duct in claim 5 secured in position by threaded locknut means adapted to tighten on the duct.

8. The removable duct in claim 6 further comprising a substantially spherical outer boss around the outer waist of the duct, said spherical outer boss intermitting with threaded slip nut means adapted to tighten on the boss to hold the duct in place.

9. The removable duct in claim 6 further comprising a ellipsoidal ring around the outer waist of the duct, said ellipsoidal ring interfitting with threaded slip nut means adapted to tighten on the ring to hold the duct in place.

10. A ski for either water skiing or for use on snow comprising, in combination,
a planar composite structure having a top side and a bottom side, and a means for scooping the material of what the ski is sliding on from part of the bottom side of the planar composite surface and passing that material through at least one orifice in the planar surface, whereby the snow is ejected at an acute angle above the top side of the planar surface.
